(19) United States
(12) Patent Application Publication
(10) Pub. No.: US 2012/0197522 A1
(43) Pub. Date: Aug. 2, 2012

(54) NAVIGATION DEVICE

(76) Inventor: Hideki Fukuhara, Tokyo (JP)

(21) Appl. No.: 13/501,186

(22) PCT Filed: Dec. 25, 2009
(86) PCT No.: PCT/JP2009/007275

§ 371 Date: Apr. 10, 2012

(51) Int. Cl. G01C 21/34

(52) U.S. Cl. 701/424

(57) ABSTRACT

In order to be able to help a user improve his or her ability to memorize routes, a navigation device includes a driving mode acquiring unit for acquiring a set-up driving mode, a driving history acquiring unit for acquiring driving history information about the navigation device itself, and a device control unit for controlling a route guidance mode at a branch point on a route searched for according to the driving history information acquired by the driving history acquiring unit when the driving mode acquired by the driving mode acquiring unit is a route memorizing mode for providing an improvement in the ability to memorize routes.

### FIELD OF THE INVENTION

The present invention relates to a navigation device that guides a user to a destination. More particularly, it relates to a technique of helping the user improve his or her ability to memorize routes.

### BACKGROUND OF THE INVENTION

For example, patent reference 1 discloses, as a device related to a navigation device, an information providing device which, when a driver is getting lost, can provide the driver with information (landmarks) about proper candidates for his or her destination without causing the driver to perform an operation of setting a route again. This information providing device detects whether or not the driver is getting lost when traveling along the route to be traveled from the amount of movement of the driver's line of sight which is acquired from the driver's eye movements which are detected from a plurality of images of the driver's face, and the amounts of operation (the steering wheel operation amount, the accelerator operation amount, and the brake operation amount).

Furthermore, patent reference 2 discloses a navigation device for vehicles which prevents excessive guidance information from being provided for a user, thereby being able to reduce the load imposed on the user when driving his or her car. This navigation device for vehicles creates and provides guidance information suited to the user according to user driving information showing the user's driving characteristics (the probability that the user makes the mistake of straying off the route which is scheduled to travel, the probability that the user forgets to perform a predetermined driving operation, or the like) which the navigation device creates from the user's driving history. The guidance information also includes landmark information which is provided for the user according to detection of whether or not the user is getting lost.

### RELATED ART DOCUMENT

### Patent Reference

Patent reference 1: Japanese Unexamined Patent Application Publication No. 2007-271480
Patent reference 2: Japanese Unexamined Patent Application Publication No. 2008-064483

Because the technique disclosed by above-mentioned patent reference 1 is aimed at providing a landmark for the user according to detection of whether or not the user is getting lost, and does not suppress the number of route guidance modes (the frequency at which route guidance information is provided or the number of methods of providing route guidance information), the technique does not help the user improve his or her ability to memorize routes. Furthermore, because the technique disclosed by patent reference 2 is aimed at providing guidance information according to the user's driving characteristics, and providing the guidance information is based on the premise that the user does not make the mistake of taking a wrong route, the technique does not help the user improve his or her ability to memorize routes.

The present invention is made in order to solve the above-mentioned problems, and it is therefore an object of the present invention to provide a navigation device that can help the user improve his or her ability to memorize routes.

### SUMMARY OF THE INVENTION

In accordance with the present invention, there is provided a navigation device including: a driving mode acquiring unit for acquiring a set-up driving mode; a driving history acquiring unit for acquiring driving history information about the navigation device itself; and a device control unit for controlling a route guidance mode at a branch point on a route searched for according to the driving history information acquired by the driving history acquiring unit when the driving mode acquired by the driving mode acquiring unit is a route memorizing mode which provides an improvement in an ability to memorize routes.

Even when the user is traveling along a route along which he or she has traveled, it is difficult for a typical car navigation device to help the user memorize the route unless he or she is aware of increase in the number of times that he or she has traveled along the route or has the will to memorize the route. In contrast, because the navigation device in accordance with the present invention controls the route guidance mode at each branch point according to the driving history information in such a way that the route guidance mode is set to one of “no output mode”, “only display output mode”, “only voice output mode” and “display and voice output mode”, the navigation device can help the user improve his or her ability to memorize routes.

### BRIEF DESCRIPTION OF THE FIGURES

FIG. 1 is a view schematically showing the structure of a car navigation system to which a navigation device in accordance with Embodiment 1 of the present invention is applied;

FIG. 2 is a block diagram showing the detailed structure of the navigation device in accordance with Embodiment 1 of the present invention;

FIG. 3 is a view showing the structure of a database which constructs the car navigation system in accordance with Embodiment 1 of the present invention;

FIG. 4 is a view showing the structure of various sensors which construct the car navigation system in accordance with Embodiment 1 of the present invention;

FIG. 5 is a view showing a flow of pieces of information which are transmitted between components until guide control information about a branch point existing on a route to a destination is determined in the navigation device in accordance with Embodiment 1 of the present invention;

FIG. 6 is a flow chart showing the operation of the navigation apparatus in accordance with Embodiment 1 of the present invention;

FIG. 7 is a view for explaining an example of correction of a numerical value representing experiences included in driving history information of the navigation device in accordance with Embodiment 1 of the present invention;

FIG. 8 is a view for explaining another example of correction of a numerical value representing experiences included in driving history information of the navigation device in accordance with Embodiment 1 of the present invention;

FIG. 9 is a view schematically showing the structure of a car navigation system to which a navigation device in accordance with Embodiment 2 of the present invention is applied; and

FIG. 10 is a block diagram showing the detailed structure of the navigation device in accordance with Embodiment 2 of the present invention.

### EMBODIMENTS OF THE INVENTION

Hereafter, in order to explain this invention in greater detail, the preferred embodiments of the present invention will be described with reference to the accompanying drawings. Embodiment 1.

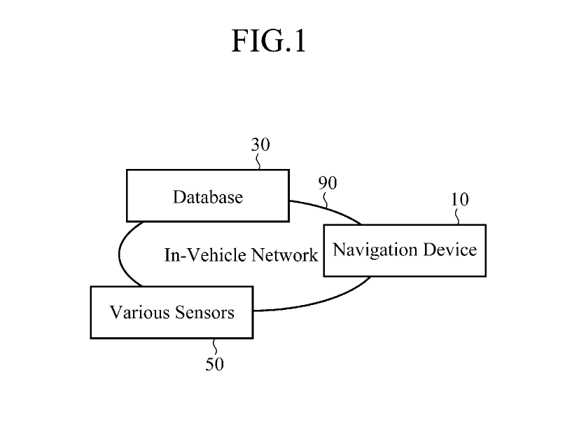

FIG. 1 is a view schematically showing the structure of a car navigation system to which a navigation device in accordance with Embodiment 1 of the present invention is applied. This car navigation system is provided with the navigation device 10, a storage unit in which a database 30 is constructed, and various sensors 50, and these components are connected to one another via an in-vehicle network 90 so that communications can be carried out among them.

The navigation device 10 consists of, for example, a computer, and guides a user along a route from a current position to a destination. A driving history showing the user's past experiences at branch points and destination information about the addresses of destinations are registered in the database 30. The various sensors 50 detect driving conditions including the user's line of sight, the user's heart rate, an image of an area in front of a vehicle, and vehicle information (the vehicle speed, the amount the user turns the steering wheel, etc.), and informs the driving conditions to the navigation device 10 as driving condition information. The in-vehicle network 90 is a radio or wired communications line which connects the navigation device 10, the storage unit in which the database 30 is constructed, and the various sensors 50 to one another.

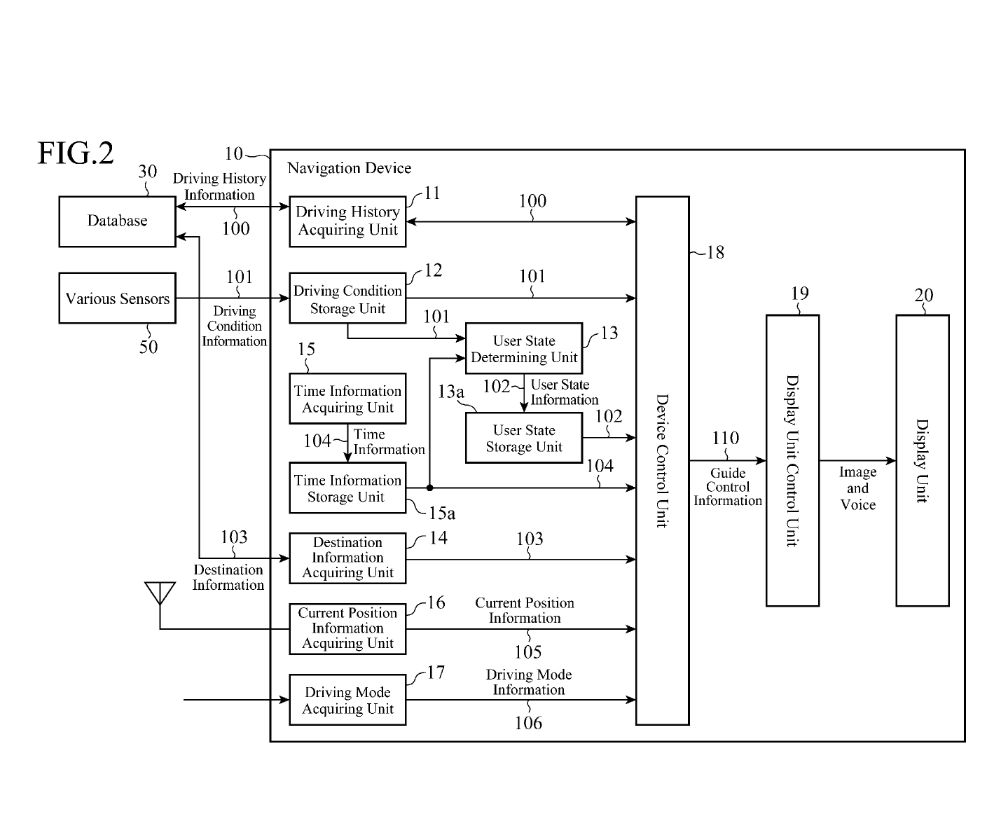

FIG. 2 is a block diagram showing the detailed structure of the navigation device 10. This navigation device 10 is provided with a driving history acquiring unit 11, a driving condition storage unit 12, a user state determining unit 13, a user state storage unit 13a, a destination information acquiring unit 14, a time information acquiring unit 15, a time information storage unit 15a, a current position information acquiring unit 16, a driving mode acquiring unit 17, a device control unit 18, a display unit control unit 19, and a display unit 20.

The driving history acquiring unit 11 acquires driving history information 100 from the database 30 via the in-vehicle network 90, and sends the driving history information to the device control unit 18. The driving history acquiring unit 11 also receives updated driving history information 100 sent thereto from the device control unit 18, and sends the updated driving history information to the database 30 to register the updated driving history information in the database.

The driving condition storage unit 12 stores the driving condition information 101 sent thereto via the in-vehicle network 90 from the various sensors 50. This driving condition information 101 stored in the driving condition storage unit 12 is read by the device control unit 18 while the driving condition information 101 is read by the user state determining unit 13 at predetermined time intervals.

The user state determining unit 13 determines whether or not the user is getting lost on the basis of both the driving condition information 101 read from the driving condition storage unit 12 and time information 104 read from the time information storage unit 15a, and informs the result of the determination to the user state storage unit 13a as user state information 102. A method of determining whether or not the user is getting lost which the user state determining unit 13 uses will be mentioned below. The user state storage unit 13a stores the user state information 102 sent thereto from the user state determining unit 13. This user state information 102 stored in the user state storage unit 13a is read by the device control unit 18.

The destination information acquiring unit 14 acquires destination information 103. For example, this destination information acquiring unit 14 is implemented as an HMI (Human Machine Interface) which enables the user to set up a destination on a screen for setup of a destination displayed on the display unit 20 by using an input unit (not shown) standardly mounted in the navigation device 10. This destination information 103 acquired by the destination information acquiring unit 14 is sent to the database 30 via the in-vehicle network 90 and is registered in the database while the destination information 103 is sent to the device control unit 18. The destination information acquiring unit 14 can also acquire destination information 103 which was registered in the past from the database 30.

The time information acquiring unit 15 acquires the time information 104 such as the current time. As this time information acquiring unit 15, for example, a timer mounted in the computer which constructs the navigation device 10 can be used. This time information 104 acquired by the time information acquiring unit 15 is sent to the time information storage unit 15a. The time information storage unit 15a stores the time information 104 sent thereto from the time information acquiring unit 15. This time information 104 stored in the time information storage unit 15a is read by the user state determining unit 13 and the device control unit 18.

The current position information acquiring unit 16 acquires current position information 105 showing the current traveling position of the vehicle, or the like. For example, this current position information acquiring unit 16 acquires position information from a GPS (Global Positioning System) sensor, an acceleration sensor, and so on to measure the vehicle position. The current position information acquiring unit thus acquires the position information as the current position information 105. This current position information 105 acquired by the current position information acquiring unit 16 is sent to the device control unit 18.

The driving mode acquiring unit 17 acquires driving mode information 106 showing a driving mode such as a navigation mode or a route memorizing mode. For example, this driving mode acquiring unit 17 is implemented as an HMI which enables the user to set up a driving mode on a screen for input displayed on the display unit 20 by using the input unit (not shown) standardly mounted in the navigation device 10. This driving mode information 106 acquired by the driving mode acquiring unit 17 is sent to the device control unit 18. In this case, a key operation unit or a voice input unit installed in the navigation device 10 can be used as the input unit.

The device control unit 18 determines guide control information 110 about a branch point on the route to the destination on the basis of the driving history information 100 sent thereto from the driving history acquiring unit 11, the user state information 102 sent thereto from the user state storage unit 13a, the destination information 103 sent thereto from the destination information acquiring unit 14, the time information 104 sent thereto from the time information storage unit 15a, the current position information 105 sent thereto from the current position information acquiring unit 16, and the driving mode information 106 sent thereto from the driving mode acquiring unit 17, and sends the guide control information to the display unit control unit 19. The device control unit 18 also updates the driving history information 100. A method of determining the guide control information 110, and a method of updating the driving history information 100 will be mentioned below.

The display unit control unit 19 creates guidance information about the branch point on the basis of the guide control information 110 from the device control unit 18, and sends the guidance information to the display unit 20. The display unit 20 displays the guidance information about the branch point which is sent thereto from the display unit control unit 19. This display unit 20 includes an audio output unit such as a speaker in addition to a display such as LCD (Liquid Crystal Display) mounted in the navigation device. For example, the guidance information about the branch point on the route to the destination is outputted via voice from the speaker while the guidance information is displayed on the display screen of the display unit 20.

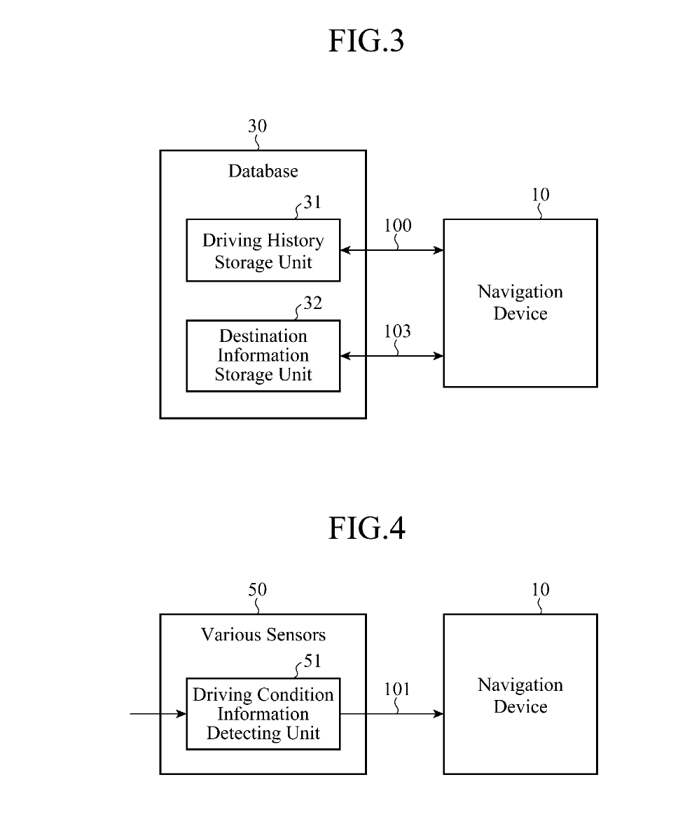

FIG. 3 is a block diagram showing the detailed structure of the database 30. A driving history storage unit 31 for storing the driving history information 100, and a destination information storage unit 32 for storing the destination information 103 are disposed in the database 30. The driving history information 100 stored in the driving history storage unit 31 and the destination information 103 stored in the destination information storage unit 32 are read by the navigation device 10.

Although an external storage connected via the in-vehicle network 90 to the navigation device can be used as the storage unit in which the database 30 is constructed, a storage area of a hard disk drive unit built in the navigation device 10 can be alternatively used.

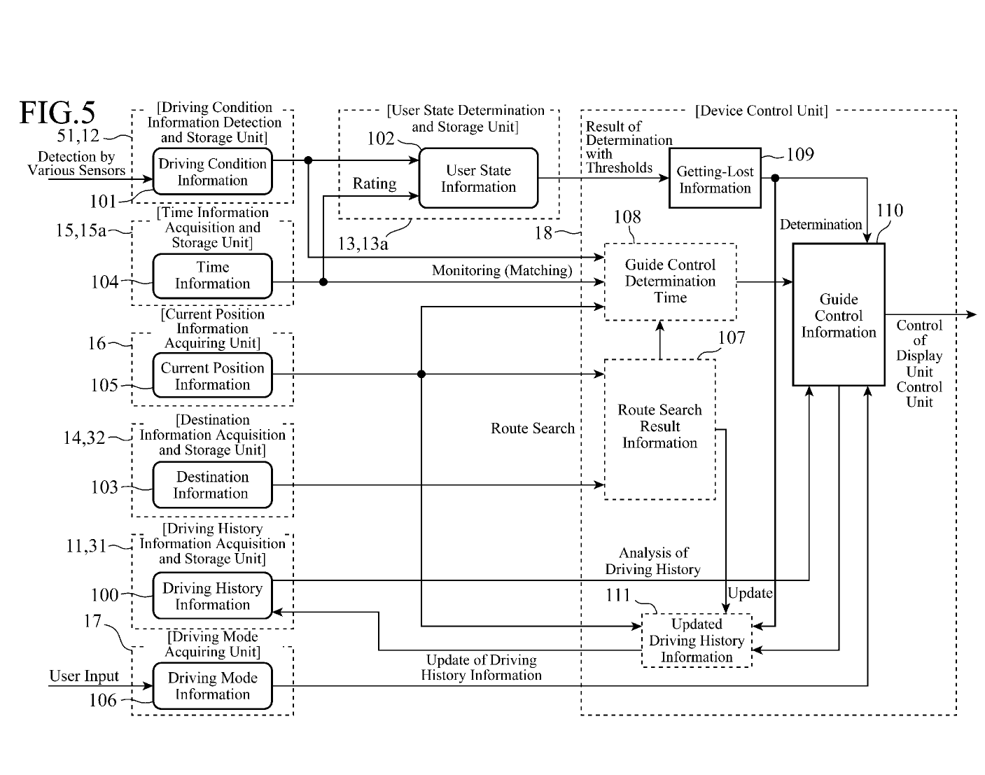

FIG. 4 is a block diagram showing the detailed structure of the various sensors 50. A driving condition information detecting unit 51 for detecting driving conditions and creating driving condition information 101 is disposed in the various sensors 50. For example, this driving condition information detecting unit 51 includes a camera for capturing an image of the user, a heart rate sensor for measuring the user's heart rate, a temperature sensor for measuring the temperature of the user's face, and a speed sensor for measuring the speed of the vehicle. In addition to these sensors, the driving condition information detecting unit includes a processing unit (not shown) for converting each of signals outputted from these sensors into information which the navigation device 10 can process to create driving condition information 101.

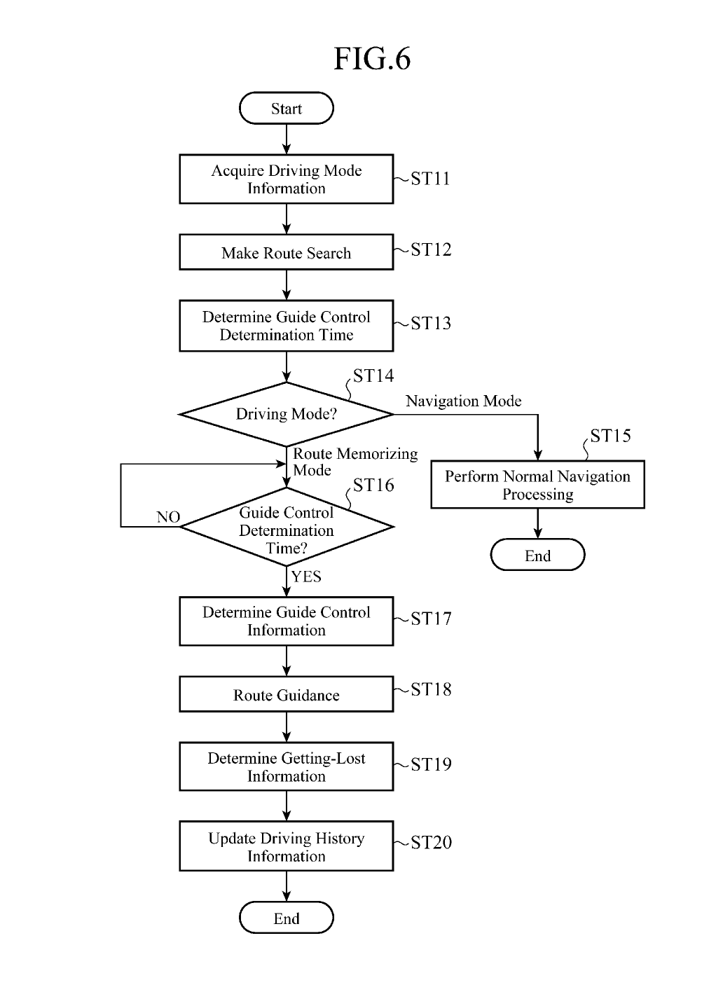

Next, the operation of the navigation device in accordance with Embodiment 1 of the present invention constructed as above will be explained with reference to an explanatory drawing shown in FIG. 5 and a flow chart shown in FIG. 6. FIG. 5 is a view showing a flow of pieces of information which are transmitted between the components until the guide control information 110 about a branch point existing on a route to a destination is determined. Hereafter, an example in which the driving mode shown by the driving mode information 106 is set to the “route memorizing mode” will be mainly explained.

First, the driving mode information is acquired in pre-processing before the user starts driving (step ST11). More specifically, the driving mode acquiring unit 17 acquires the driving mode information 106 inputted by the user. The driving mode shown by the driving mode information 106 can be the normal navigation mode in which no guide control is carried out or the route memorizing mode in which guide control is carried out. The driving mode acquiring unit 17 displays a screen for input on which a setting item is provided to allow the user to input the driving mode information 106 on the display unit 20. When the user uses a key operation unit or a voice input unit to set information to the setting item on this screen for input, the driving mode acquiring unit 17 acquires the information as the driving mode information 106, and sends this driving mode information to the device control unit 18.

A route search is then performed (step ST12). More specifically, the device control unit 18 makes a search for a route from the current position shown by the current position information 105 from the current position information acquiring unit 16 to the destination shown by the destination information 103 from the destination information acquiring unit 14 to acquire route search result information 107.

A setup of a guide control determination time is then performed (step ST13). More specifically, the device control unit 18 sets up a guide control determination time 108 which is the one that the navigation device outputs the guide control information 110 at each branch point on the basis of the route search result information 107 acquired in step ST12. For example, as the guide control determination time 108, the time that the vehicle reaches a point at a distance of 30 m before each branch point or the time at 30 seconds before the vehicle enters each branch point is set up. The setup of the guide control determination timing 108 can be carried out every time when the route is changed. After that, the user starts driving.

After the user starts driving, the driving mode is checked to see first (step ST14). More specifically, the device control unit 18 acquires the driving mode information 106 acquired in step ST11 from the driving mode acquiring unit 17, and checks to see whether this driving mode information 106 shows the “navigation mode” or “the route memorizing mode”. When it is determined, in this step ST14, that the driving mode shows the navigation mode, normal navigation processing is carried out (step ST15). Because this normal navigation processing is well known, the explanation of the normal navigation processing will be omitted hereafter. After that, the normal navigation processing is ended.

When it is determined, in above-mentioned step ST14, that the driving mode shows the route memorizing mode, whether the current time reaches the guide control determination time of a branch point is checked to see (step ST16). More specifically, the device control unit 18 monitors whether the current time reaches the guide control determination time 108 of a branch point on the basis of the current position shown by the current position information 105 sent thereto from the current position information acquiring unit 16, the current time shown by the time information 104 read from the time information storage unit 15a, and the speed of the vehicle shown by the driving condition information 101 read from the driving condition storage unit 12.

When, in this step ST16, determining that when the current time does not reach the guide control determination time of any branch point, the device control unit enters a wait state in which the device control unit repeatedly carries out the process of step ST16. In contrast, when, in step ST16, determining that when the current time reaches the guide control determination time of a branch point, the device control unit determines guide control information (step ST17). More specifically, the device control unit 18 determines guide control information 110 from the driving history information 100 about the branch point which is acquired from the database 30 by the driving history acquiring unit 11.

The driving history information 100 includes the user's experiences at the branch point, i.e. the user's degree of memorization which is expressed as a numerical value ranging from 0.0 to 100.0, for example, and shows that the larger numerical value showing experiences, the higher degree of memorization about the branch point the user has. The device control unit 18 classifies the numerical value representing such the user's experiences as a level according to stepwise thresholds, and determines the guide control information 110 in such a way that the navigation device provides route guidance with a minimum amount of guidance information for the user to enable the user to memorize the route.

The route guidance is carried out in the following manner. For example, a threshold 1, a threshold 2, and a threshold 3 are provided, and, when the numerical value representing the user's experiences is less than the threshold 1, the guide control information 110 is determined in such a way that a screen display is produced and voice guidance is provided, like in the case of the normal navigation. When the numerical value representing the user's experiences is equal to or greater than the threshold 1 and less than the threshold 2, the guide control information 110 is determined in such a way that no screen display is produced and only voice guidance is provided. When the numerical value representing the user's experiences is equal to or greater than the threshold 2 and less than the threshold 3, the guide control information 110 is determined in such a way that no voice guidance is provided and only a screen display is produced. When the numerical value representing the user's experiences is equal to or greater than the threshold 3, the guide control information 110 is determined in such a way that no screen display is produced and no voice guidance is provided. In this embodiment, in order to provide an improvement in the above-mentioned ability to memorize the route, it is desirable to set the threshold 1, the threshold 2, and the threshold 3 to “3.0”, “6.0”, and “10.0”, respectively, for example, in such a way that the plural ranges divided by the thresholds extremely increase in width in the order of increasing threshold.

The route guidance is then carried out (step ST18). More specifically, the display unit control unit 19 controls the display unit 20 according to the guide control information 110 determined by the device control unit 18 in such a way that the display unit performs the route guidance at the branch point. As a result, the information about the route guidance about the branch point is displayed on the display unit 20.

Getting-lost information is then determined (step ST19). More specifically, the driving condition detecting unit 51 included in the various sensors 50 detects the driver's driving conditions, and informs the driver's driving conditions to the driving condition storage unit 12 of the navigation device 10 as driving condition information 101. This driving condition information 101 stored in the driving condition storage unit 12 is read by the user state determining unit 13. The user state determining unit 13 determines whether or not the driver is getting lost on the basis of the driving condition information 101 which the user state determining unit reads to determine getting-lost information 109.

This user state determining unit 13 carries out the determination by using the following three indices: the driver's “degree of impatience” and “degree of tension”, and the vehicle's “degree of unsteadiness” which are included in the driving condition information 101. The getting-lost information 109 is defined as one of three levels: “getting lost”, “getting lost a little”, and “not getting lost”. When the getting-lost information 109 shows “getting lost”, the above-mentioned ranges divided by the thresholds are changed. For example, when it is determined that the user is “getting lost” his or her way, it is desirable to change the threshold 1, the threshold 2, and the threshold 3 to “25.0”, “50.0”, and “75.0”, respectively, and provide route guidance with a certain amount of guidance information for the user to help the user be able to memorize the route.

In order to determine whether or not the driver is getting lost, a camera for capturing an image of an area outside the vehicle and an image of the inside of the vehicle, a sound collecting microphone for collecting a sound occurring inside the vehicle, a heart rate sensor, a temperature sensor, an acceleration sensor, a vehicle speed meter, and so on are disposed in the driving condition detecting unit 51. An information processing unit (not shown) for processing signals acquired from these components to create driving condition information 101 is also disposed in the driving condition detecting unit.

For example, the driving condition detecting unit 51 can be constructed in such a way as to extract an object existing in a direction of the driver's line of sight on the basis of the direction toward which the driver's eyes are oriented and the result of detection of a scene outside the vehicle which can be viewed from the driver's seat from the image captured by the camera, and create driving condition information 101 showing the driver's degree of impatience when the object is an indicator or indicates a forward direction from the branch point. As an alternative, the driving condition detecting unit can be constructed in such a way as to extract the driver's utterance from the sound (voice) occurring inside the vehicle which is detected by the sound collecting microphone, and create driving condition information 101 showing the driver's degree of impatience when a keyword showing that the user is getting lost is included in the content of the utterance.

Furthermore, drivers may experience a state of heightened tension because of getting lost. A heart rate sensor or a temperature sensor can be embedded in the driver's seat or the like to determine whether or not the user is in such a state of heightened tension, and the driving condition detecting unit 51 can be constructed in such a way as to create driving condition information 101 showing the driver's degree of tension according to a change of the heart rate or a change of the temperature of the user's face. Japanese Unexamined Patent Application Publication No. 2006-167425 proposes a new concept of a mental resource which is defined as an index showing the ease of occurrence of human mistakes in a vehicle driver, and discloses a mental resource evaluation system for vehicle which calculates and evaluates a mental resource on the basis of a vehicle driver's living body index. Please refer to the patent application publication as needed.

In addition, drivers may slow down their vehicles or turn their steering wheels the wrong way because of getting lost. To determine whether or not the driver has slowed down the vehicle or turned the steering wheel the wrong way, the driving condition detecting unit 51 can be constructed in such a way as to create driving condition information 101 showing the degree of unsteadiness of the vehicle on the basis of the pieces of vehicle information acquired from the acceleration sensor and the vehicle speed meter.

The driving condition information 101 is acquired by the driving condition detecting unit 51 at fixed time intervals while the vehicle is travelling, and is sent to the driving condition storage unit 12 of the navigation device 10 via the in-vehicle network 90 and is held by the driving condition storage unit. Furthermore, the time information acquiring unit 15 acquires the current time from a clock or the like which is installed in the vehicle, and holds the current time in the time information storage unit 15a as time information 104.

The user state determining unit 13 reads the time information 104 from the time information storage unit 15a while reading the driving condition information 101 from the driving condition storage unit 12, and then performs a predetermined arithmetic operation on these pieces of information to determine user state information 102 showing how much the driver is getting lost. In this case, the user state determining unit determines an index showing how much the driver is getting lost by rating the driving condition information 101 according to a predetermined rule.

For example, the user state determining unit determines the driver's degree of impatience from both the object existing in the direction of the driver's line of sight which is acquired as the driving condition information 101 and the driver's utterance by using the following equation (1).

Degree of impatience=α×(a1+a2) (1)

where a1 is the result of a multiplication of the result of matching showing whether the object existing in the direction of the driver's line of sight is an indicator or indicates a forward direction toward a wrong route from the branch point by the length of a time period (measured in seconds) during which the object has been the target for matching, and a2 is the result of matching with keywords included in the driver's utterance and showing that the driver is getting lost. α is an adjustment coefficient for adjusting the driver's degree of impatience with respect to the degree of tension and the degree of unsteadiness which are the other indices.

The user state determining unit also determines the driver's degree of tension from both the heart rate and the face temperature which are acquired as the driving condition information 101 by using the following equation (2).

Degree of tension=β×(b1+b2) (2)

where b1 is the result of a multiplication of the result of matching showing whether or not a change of the heart rate is equal to or larger than a predetermined threshold by the length of a time period (measured in seconds) during which a change of the heart rate has been equal to or larger than the predetermined threshold, and b2 is the result of determination of a change in the face temperature by using a threshold.
β is an adjustment coefficient, like α.

The user state determining unit further determines the degree of unsteadiness of the vehicle from a change of the vehicle speed or the degree of how much the vehicle is rolling which is acquired as the driving condition information 101 by using the following equation (3).

Degree of unsteadiness=γ×(c1+c2) (3)

where c1 is the result of matching showing whether or not a decrease in the speed of the vehicle is equal to or larger than a predetermined threshold and smaller than another predetermined threshold, and c2 is the result of matching showing whether or not the degree of how much the vehicle is rolling is equal to higher than a predetermined threshold.
γ is an adjustment coefficient, like α and β.

As mentioned above, the navigation device sets up a rule for rating the driving condition information 101 and a rule for rating the time information 104, and provides the results of calculation of scores as the user state information 102. The user state information 102 for each passenger which is determined in this way is stored in the user state storage unit 13a.

When determining the guide control information 110 in the above-mentioned way, the device control unit 18 determines whether or not the user is getting lost from the user state information 102 and reflects the result of this determination in the determination of the guide control information 110. The device control unit 18 also controls the operation of each component in the navigation device 10 in addition to the above-mentioned operation.

Next, the details of the determination of whether or not the user is getting lost, which is carried out by the device control unit 18, will be explained. The device control unit 18 reads the user state information 102 from the user state storage unit 13a, calculates the sum total of the index values which construct the user state information 102 to calculate the average of the index values, and determines whether or the user is getting lost according to the result of a comparison between the average and preset thresholds to determine getting-lost information 109. For example, when a threshold 4 and a threshold 5 are set up as the thresholds, the device control unit determines that “the user is not getting lost” when the average of the index values is less than the threshold 4, the device control unit determines that “the user is getting lost a little” when the average of the index values is equal to or greater than the threshold 4 and less than the threshold 5, and the device control unit determines that “the user is getting lost” when the average of the index values is equal to or greater than the threshold 5. In this case, the ranges divided by the thresholds are equal in width.

When the determination of the getting-lost information is completed in above-mentioned step ST19, an update of the driving history information is then performed (step ST20). More specifically, the device control unit 18 determines driving history information 100 at each branch point, i.e., update driving history information 111 about an update of the numerical value representing the user's experiences on the basis of the current position information 105, the route search result information 107, the getting-lost information 109, and the guide control information 110. More specifically, the device control unit 18 determines update driving history information 111 which is defined as an increase or decrease of the numerical value representing the user's experiences on the basis of the following three parameters: the getting-lost level acquired from the getting-lost information 109, the route guidance level acquired from the guide control information 110, and a passage result showing whether the vehicle has rightly passed through the branch point currently being processed which is acquired from a comparison between the current position information 105 and the route search result information 107.

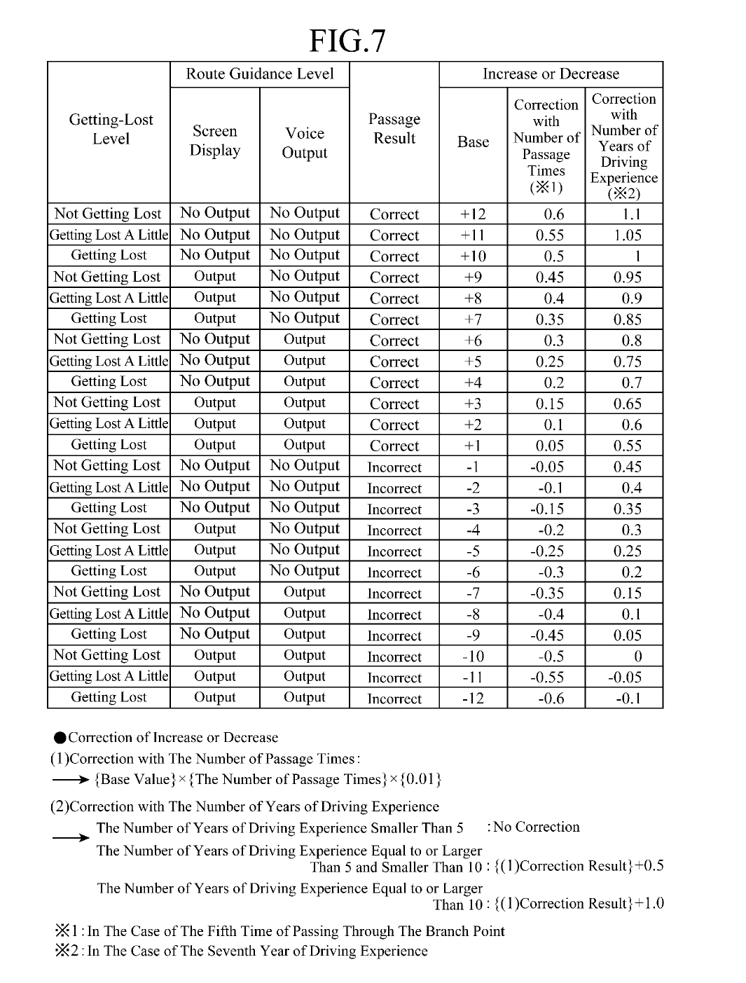

In addition, the increase or decrease is corrected according to the number of times that the driver has passed through the branch point and the number of years of driving experience which are included in the driving history information 100 acquired beforehand, and the numerical value representing the user's experiences and the number of times that the driver has passed through the branch point are updated according to the corrected increase or decrease. For example, as shown in FIG. 7, a base value for the increase or decrease is determined according to the above-mentioned getting-lost level which is one of the three levels, the above-mentioned route guidance level which is one of the four levels, and the above-mentioned passage result. Next, the increase or decrease is corrected according to the number of passage times that the driver has passed through the branch point by using the following equation (4).

The increase or decrease corrected according to the number of passage times: {base value}×{the number of passage times}×0.01 (4)

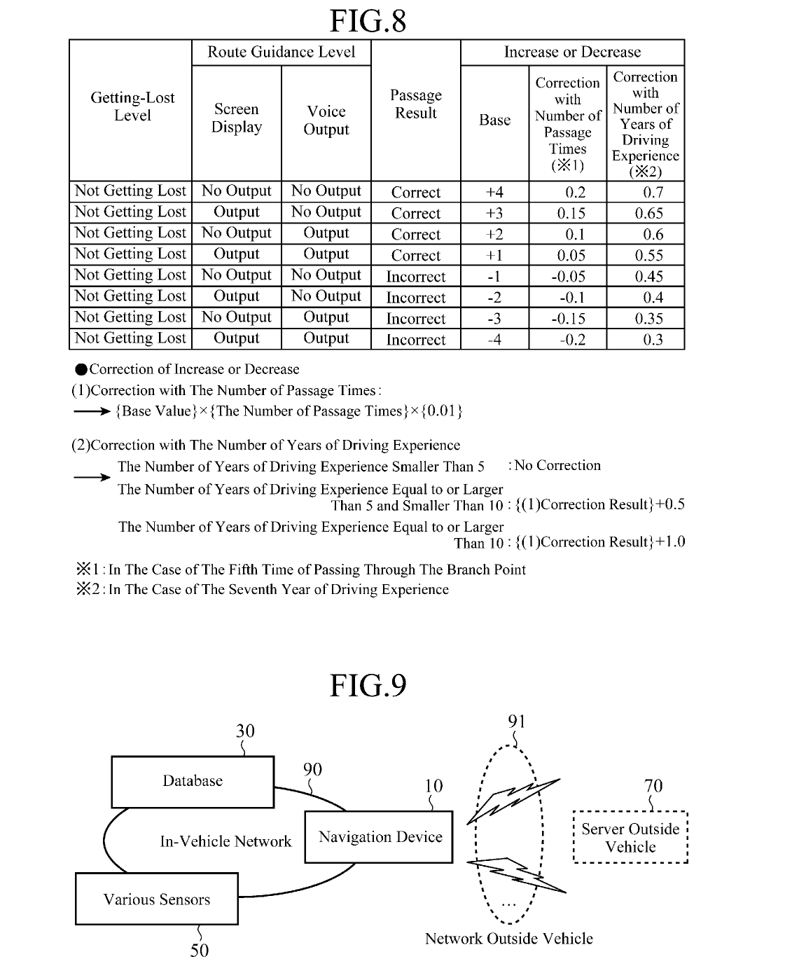

As shown in FIG. 8, the device control unit can be alternatively constructed in such a way as to neglect the above-mentioned getting-lost level which is one of the three levels, but determine the base value for the increase or decrease according to both the route guidance level which is one of the four levels, and the passage result.

The device control unit further corrects the result of the calculation using the equation (4) according to the number of years of driving experience to determine the increase or decrease. For example, when the number of years of driving experience is smaller than five, the device control unit does not make any correction to the result, when the number of years of driving experience is equal to or larger than five and smaller than ten, the device control unit adds “0.5” to the result, and when the number of years of driving experience is equal to or larger than ten, the device control unit adds “1.0” to the result. Because the numerical value representing the user's experiences is updated to the one which takes into consideration the driver's experiences at the branch point and driving experiences through the correction process, the guide control information 110 can be created in such a way as to reflect the driver's ability. After an update of the driving history information is performed as mentioned above, the navigation device ends the processing in the route memorizing mode.

As previously explained, the navigation device in accordance with Embodiment 1 of the present invention controls the route guidance mode at each branch point according to the driving history information in such a way that the route guidance mode is set to one of “no output mode”, “only display output mode”, “only voice output mode” and “display and voice output mode”, the navigation device can help the user improve his or her ability to memorize routes.

### Embodiment 2

FIG. 9 is a view schematically showing the structure of a car navigation system to which a navigation device in accordance with Embodiment 2 of the present invention is applied. This car navigation system is constructed in such a way as to include a server 70 disposed outside a vehicle in addition to the components of the car navigation system in accordance with Embodiment 1 shown in FIG. 1. The navigation device 10 and the server 70 disposed outside the vehicle are connected to each other via a network 91 disposed outside the vehicle so that they can communicate with each other.

The server 70 disposed outside the vehicle manages driving history information 112 about other users (others) including driving history information 100 about the user of the vehicle. Furthermore, the driving history information 112 about other users shows the average of numerical values representing other users' experiences for each branch point, the average being provided according to the number of years of driving experience and the number of passage times that the branch point has been passed through, like the driving history information 100. Furthermore, the network 91 disposed outside the vehicle can consist of a radio communications line which connects between the navigation device 10 and the server 70 disposed outside the vehicle.

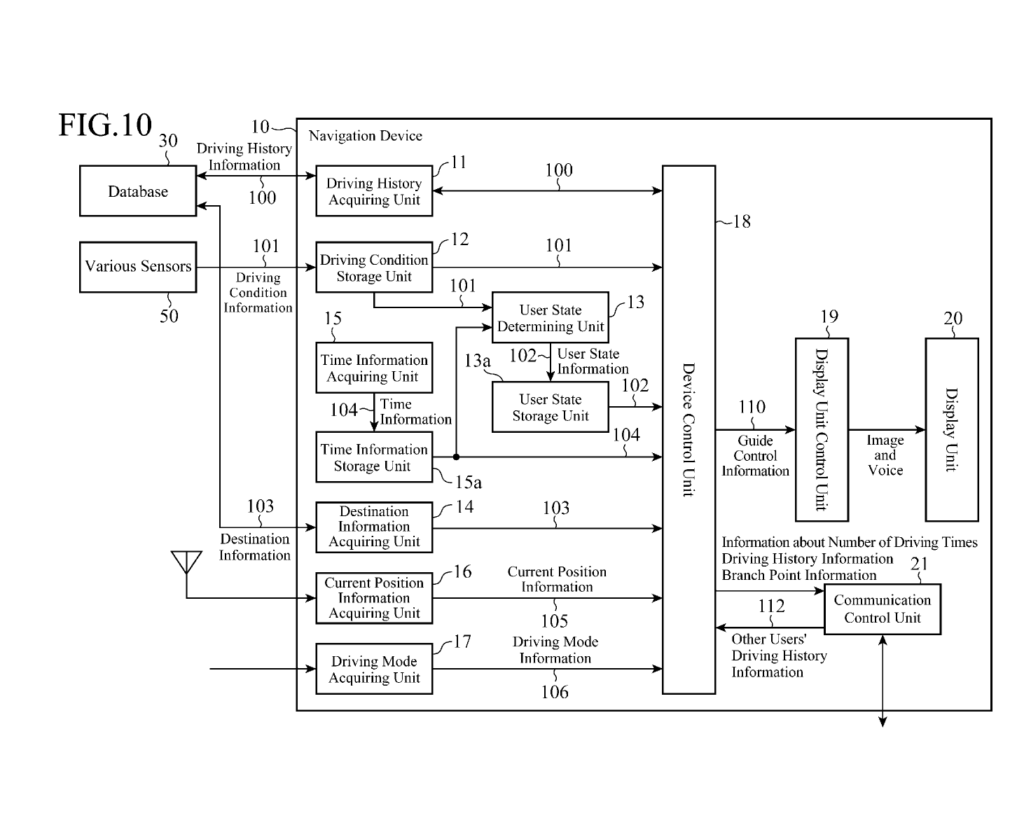

FIG. 10 is a block diagram showing the structure of the navigation device in accordance with Embodiment 2. This navigation device 10 is constructed in such a way as to include a communication control unit 21 in addition to the components of the navigation device in accordance with Embodiment 1 shown in FIG. 2. The communication control unit 21 communicates with the server 70 disposed outside the vehicle via the network 91 disposed outside the vehicle, and transmits and receives information to and from the server 70.

Next, the operation of the navigation device in accordance with Embodiment 2 of the present invention will be explained. Hereafter, a case in which a driving mode shown by driving mode information 106 is set to a “route memorizing mode”, like in the case of the navigation device in accordance with above-mentioned Embodiment 1, and the navigation device determines guide control information 110 according to the driving history information 100 when the current time reaches the guide control determination time 108 of a branch point will be explained as an example.

When the current time reaches the guide control determination time 108 of a branch point, the communication control unit 21 acquires the driving history information 112 about the branch point and about each of other users having substantially the same number of years of driving experience and substantially the same number of times that the branch point has been passed through as those of the user from the server 70 disposed outside the vehicle via radio communications. More specifically, the communication control unit acquires the average of the numerical values representing the experiences which other users having substantially the same experiences as the driver have from the server. By using this average of the numerical values representing other users' experiences, the navigation device adjusts a threshold which it uses at the time of determining the guide control information 110, and then determines the guide control information 110 according to the degree of difficulty of the branch point.

For example, because it can be determined that the degree of difficulty of the branch point is low when the average of the numerical values representing other users' experiences is higher than the numerical value representing the driver's experiences by a predetermined value, the navigation device sets the threshold to a value equal to or smaller than those set for the numerical value representing the driver's experiences and getting-lost information 109, and determines the guide control information 110 in such a way that the frequency at which route guidance is carried out decreases. In contrast, because it can be determined that the degree of difficulty of the branch point is high when the average of the numerical values representing other users' experiences is lower than the numerical value representing the driver's experiences by a predetermined value or more, the navigation device sets the threshold to a value equal to or larger than those set for the numerical value representing the driver's experiences and the getting-lost information 109, and determines the guide control information 110 in such a way that route guidance with a certain amount of guidance information is carried out. As a result, the navigation device enables the user to improve his or her ability to memorize routes in consideration of the degree of difficulty of each branch point.

The navigation device can be alternatively constructed in such a way as not to use the numerical value representing the driver's experiences, but to use only the average of the numerical values representing other users' experiences to determine the guide control information 110 by using the same method as that shown in Embodiment 1. According to this structure, the navigation device enables even a user who has not experienced driving in the “route memorizing mode” an adequate number of times to improve his or her ability to memorize routes in consideration of the degree of difficulty of each branch point.

### INDUSTRIAL APPLICABILITY

The present invention can be used for a car navigation system which is required to avoid presentation of unnecessary guidance information for the driver when the driver keeps the route, along which the driver is driving his or her car, in mind.

1.-4. (canceled)

5. A navigation device comprising:
a driving mode acquiring unit for acquiring a set-up driving mode;
a driving history acquiring unit for acquiring driving history information about a user;
a device control unit for controlling a route guidance mode at a branch point on a route searched for according to the driving history information acquired by said driving history acquiring unit when the driving mode acquired by said driving mode acquiring unit is a route memorizing mode which provides an improvement in an ability to memorize routes;
a driving condition storage unit for storing driving condition information from a sensor for detecting the user's condition; and
a user state determining unit for determining the user's state on a basis of the driving condition information read from said driving condition storage unit, wherein
said device control unit controls the route guidance mode at the branch point on the route searched for according to the driving history information acquired by said driving history acquiring unit and the user's state determined by said user state determining unit.

6. The navigation device according to claim 5, wherein said navigation device comprises a communication control unit for communicating with a server disposed outside a vehicle, and wherein the device control unit controls the route guidance mode at the branch point on the route searched for by using other persons' driving history information which said communication control unit acquires by communicating with the server disposed outside the vehicle.

7. The navigation device according to claim 5, wherein the device control unit determines update driving history information according to getting-lost information showing whether a driver is getting lost at the branch point on the route searched for, and updates the driving history information acquired by the driving history acquiring unit by using said determined update driving history information.

8. A navigation device comprising:
a driving mode acquiring unit for acquiring a set-up driving mode;
a driving history acquiring unit for acquiring driving history information about a user;
a device control unit for controlling a route guidance mode at a branch point on a route searched for according to the driving history information acquired by said driving history acquiring unit when the driving mode acquired by said driving mode acquiring unit is a route memorizing mode which provides an improvement in an ability to memorize routes; and
a communication control unit for communicating with a server disposed outside a vehicle,
wherein said device control unit controls the route guidance mode at the branch point on the route searched for by using driving history information about others having substantially same driving experiences as the user's driving experiences, which said communication control unit acquires by communicating with the server disposed outside the vehicle.
